(19) United States
(12) Patent Application Publication
(10) Pub. No.: US 2022/0297683 A1
(43) Pub. Date: Sep. 22, 2022

(54) VEHICLE GUARD RAIL SYSTEM

(71) Applicant: Toyota Motor Engineering & Manufacturing North America, Inc., Plano, TX (US)

(72) Inventors: Rohit Gupta, Santa Clara, CA (US); Ziran Wang, San Jose, CA (US); Kyungtae Han, Palo Alto, CA (US); Prashant Tiwari, Santa Clara, CA (US)

(21) Appl. No.: 17/206,706

(22) Filed: Mar. 19, 2021

(51) Int. Cl. B60W 30/09; G08G 1/16; G08G 1/052; G08G 1/056; B60W 50/16; B60W 30/095

(52) U.S. Cl. CPC B60W 30/09; G08G 1/166; G08G 1/052; G08G 1/056; B60W 50/16; B60W 30/0956; B60W 2520/06; B60W 2520/10; B60W 2555/00

(57) ABSTRACT

Systems, methods, and other embodiments described herein relate to guiding a vehicle along a path. In one embodiment, a method includes generating a virtual environment that includes a virtual version of the path and a marker indicating a demarcation along the path. The method includes generating a virtual rendition of the vehicle in the virtual environment. The virtual rendition of the vehicle including a virtual version of the vehicle and one or more guard rails that are spaced from the perimeter of the virtual version of the vehicle. The method includes predicting whether the virtual rendition of the vehicle will intersect with the marker, and determining an act to assist in preventing the virtual rendition of the vehicle from intersecting with the marker.

### TECHNICAL FIELD

The subject matter described herein relates, in general, to systems and methods for guiding a vehicle along a path.

### BACKGROUND

Modern vehicles may include one or more sensors that detect and relay information about the environment in which the vehicle is travelling. Some vehicles and/or drivers may require aids such as lane markers in the environment to determine how to operate the vehicle within the environment. In an environment lacking such aids, the vehicle and/or driver may be incapable of determining how to operate the vehicle within that environment.

### SUMMARY

In one embodiment, a method for guiding a vehicle along a path is disclosed. The method includes generating a virtual environment that includes a virtual version of the path and a marker indicating a demarcation along the path. The method also includes generating a virtual rendition of the vehicle in the virtual environment. The virtual rendition of the vehicle includes a virtual version of the vehicle and one or more guard rails that are spaced from the perimeter of the virtual version of the vehicle. The method includes predicting whether the virtual rendition of the vehicle will intersect with the marker, and determining an act to assist in preventing the virtual rendition of the vehicle from intersecting with the marker.

In one embodiment, a system for guiding a vehicle along a path is disclosed. The system includes one or more processors, and a memory in communication with the one or more processors. The memory stores a virtual environment generation module including instructions that when executed by the one or more processors cause the one or more processors to generate a virtual environment that includes a virtual version of the path and a marker indicating a demarcation along the path, and generate a virtual rendition of the vehicle in the virtual environment. The virtual rendition of the vehicle includes a virtual version of the vehicle and one or more guard rails that are spaced from the perimeter of the virtual version of the vehicle. The memory stores a collision prediction module including instructions that when executed by the one or more processors cause the one or more processors to predict whether the virtual rendition of the vehicle will intersect with the marker. The memory stores a response generation module including instructions that when executed by the one or more processors cause the one or more processors to determine an act to assist in preventing the virtual rendition of the vehicle from intersecting with the marker.

In another embodiment, a non-transitory computer-readable medium for guiding a vehicle along a path and including instructions that when executed by one or more processors cause the one or more processors to perform one or more functions, is disclosed. The instructions include instructions to generate a virtual environment that includes a virtual version of the path and a marker indicating a demarcation along the path. The instructions further include instructions to generate a virtual rendition of the vehicle in the virtual environment. The virtual rendition of the vehicle includes a virtual version of the vehicle and one or more guard rails that are spaced from the perimeter of the virtual version of the vehicle. The instructions further include instructions to predict whether the virtual rendition of the vehicle will intersect with the marker, and determining an act to assist in preventing the virtual rendition of the vehicle from intersecting with the marker.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an example of a vehicle guard rail system.

FIG. 2 illustrates a block diagram of a vehicle incorporating a vehicle guard rail system.

FIG. 3 illustrates one embodiment of a vehicle guard rail system.

FIG. 4 illustrates a diagram of a vehicle guard rail system in a cloud-based configuration.

FIG. 5 is a flowchart illustrating one embodiment of a method associated with guiding a vehicle along a path.

FIGS. 6A-6B are an example of a vehicle path guidance scenario.

### DETAILED DESCRIPTION

Systems, methods, and other embodiments associated with guiding a vehicle along a path are disclosed. A vehicle travelling on a path, more specifically, an unmarked or a poorly marked path that lacks lane markings, adequate paving, and/or lighting, may be unable to determine a lane on which it can safely travel without obstructing and/or colliding with other road users.

Accordingly, in one embodiment, the disclosed approach is a system that guides a vehicle along a path. As an example, the system can receive sensor data from the vehicle sensors. The vehicle sensors, which can include an on-board camera and/or a LiDAR sensor, can detect the road, other vehicles and objects on the road. The system can receive information about the vehicle from the vehicle using any suitable communication method. The information can include the vehicle type, vehicle performance capability, dimensions of the vehicle, safety ratings of the vehicle, etc. The system can extract information about other vehicles and/or objects from the sensor data. In a case where the system is unable to extract the information from the sensor data, the system may retrieve information for similar vehicles and/or objects from a database such as an environment information database, a vehicle information database and/or any suitable database with historical information. The system may use any suitable algorithm to determine similarity and whether the vehicle and/or object matches an item in the database.

The system can determine traffic patterns and/or the trajectories of the vehicles and/or objects on the road based on the sensor data. The system can generate a virtual environment based on the environment surrounding the vehicle. The system can generate one or more markers in the virtual environment that indicates one or more boundaries of a path in which the vehicle can travel without obstructing other vehicles. The system can generate a virtual rendition of the vehicle, other vehicles, and/or objects in the virtual environment, where the positions and trajectories of the virtual renditions of the vehicle, other vehicles, and objects mimic the positions and trajectories of the vehicle, other vehicles and objects, respectively. The system can predict a collision based on the positions and/or trajectory of the virtual renditions of the vehicle, other vehicles and/or objects.

In a case where the system predicts a collision, the system can send an alert to the vehicle and/or the driver. The alert can be visual, audible and/or haptic. As another example, the system can take control of the vehicle in such a case. In that example, the system can take control of the steering wheel and redirect the vehicle and/or take control of the brakes and stop or slow down the vehicle.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

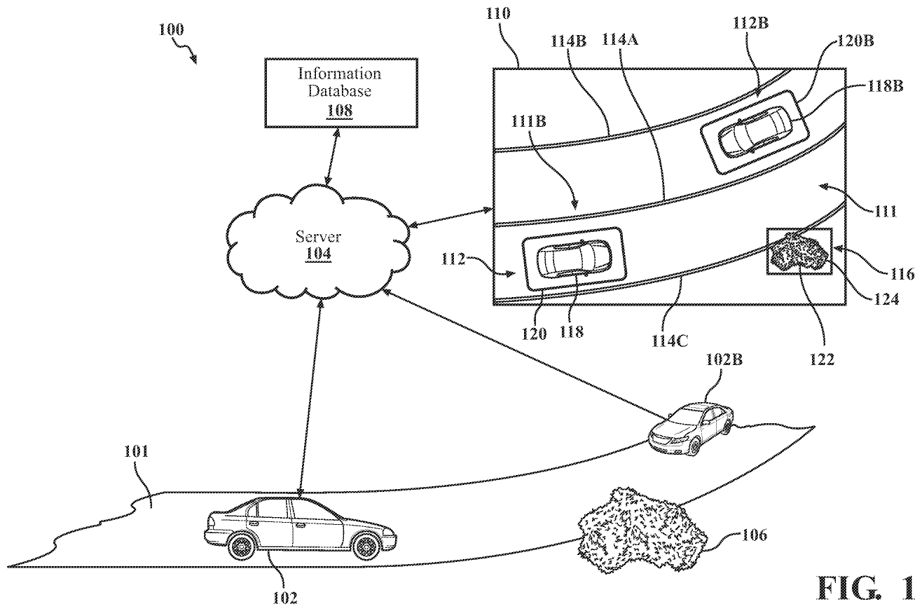

Referring to FIG. 1, an example of a vehicle guard rail system 100 is shown. The vehicle guard rail system 100 may include various elements, which may be communicatively linked in any suitable form. As an example, the elements may be connected, as shown in FIG. 1. Some of the possible elements of the vehicle guard rail system 100 are shown in FIG. 1 and will now be described. It will be understood that it is not necessary for the vehicle guard rail system 100 to have all the elements shown in FIG. 1 or described herein. The vehicle guard rail system 100 may have any combination of the various elements shown in FIG. 1. Further, the vehicle guard rail system 100 may have additional elements to those shown in FIG. 1. In some arrangements, the vehicle guard rail system 100 may not include one or more of the elements shown in FIG. 1. Further, it will be understood that one or more of these elements may be physically separated by large distances.

The elements of the vehicle guard rail system 100 may be communicatively linked through one or more communication networks. As used herein, the term “communicatively linked” can include direct or indirect connections through a communication channel or pathway or another component or system. A “communication network” means one or more components designed to transmit and/or receive information from one source to another. The one or more of the elements of the vehicle guard rail system 100 may include and/or execute suitable communication software, which enables the various elements to communicate with each other through the communication network and perform the functions disclosed herein.

The one or more communication networks can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network further can be implemented as or include one or more wireless networks, whether short-range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long-range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

The vehicle guard rail system 100 can include one or more connected vehicles 102, 102B. As used herein, “vehicle” means any form of motorized transport. In one or more implementations, the vehicle can be an automobile. While arrangements will be described herein with respect to automobiles, it will be understood that embodiments are not limited to automobiles. In some implementations, the vehicle 102 may be any device that, for example, transports passengers and includes the noted sensory devices from which the disclosed predictions and determinations may be generated. The vehicle can be any other type of vehicle that may be used on a roadway, such as a motorcycle. In some implementation, the vehicle can be a watercraft, an aircraft, or any other form of motorized transport. The vehicle 102 can be a connected vehicle that is communicatively linked to one or more elements of the vehicle guard rail system 100.

The vehicle guard rail system 100 can include one or more entities that may exchange information with the vehicle 102. The entities may include other vehicles 102B, roadside units, vehicle manufacturers, and/or other information databases.

The vehicle guard rail system 100 can include one or more servers 104. The server(s) 104 may be, for example, cloud-based server(s) or edge-based server(s). The server(s) 104 can communicate with one or more vehicles 102, 102B over a communication module, such as by any type of vehicle-to-cloud (V2C) communications, now known or later developed. The server(s) 104 can receive data from and send data to the vehicle(s) 102. Alternatively and/or additionally, the server 104, vehicle 102 and the other entities 102B, 108 may communicate over other suitable means such as vehicle-to-vehicle (V2V) communications, vehicle-to-everything (V2X) communications.

The vehicle guard rail system 100 can generate a virtual environment 110 with markers 114A, 114B, 114C (collectively known as 114) indicating various virtual paths 111, 111B of travel based on the path 101 that the vehicle 102 is travelling on. The vehicle guard rail system 100 can generate virtual renditions 112, 112B of vehicles 102, 102B in the environment. The virtual renditions 112, 112B of the vehicles 102, 102B can include virtual versions 118, 118B of the vehicles 102, 102B and guard rails 120, 120B spaced from the virtual versions 118, 118B of the vehicles 102, 102B. The vehicle guard rail system 100 can generate a virtual rendition 116 of an object 106 in the environment. The virtual rendition 116 of the object 106 can include a virtual version 122 of the object 106 and guard rails 124 spaced from the virtual version 122 of the object 106. The virtual environment 110 including the markers 114 and virtual renditions 112, 112B, 116 of the vehicles 102, 102B and other objects 106 in the environment may be displayed on a display interface visible to a vehicle operator.

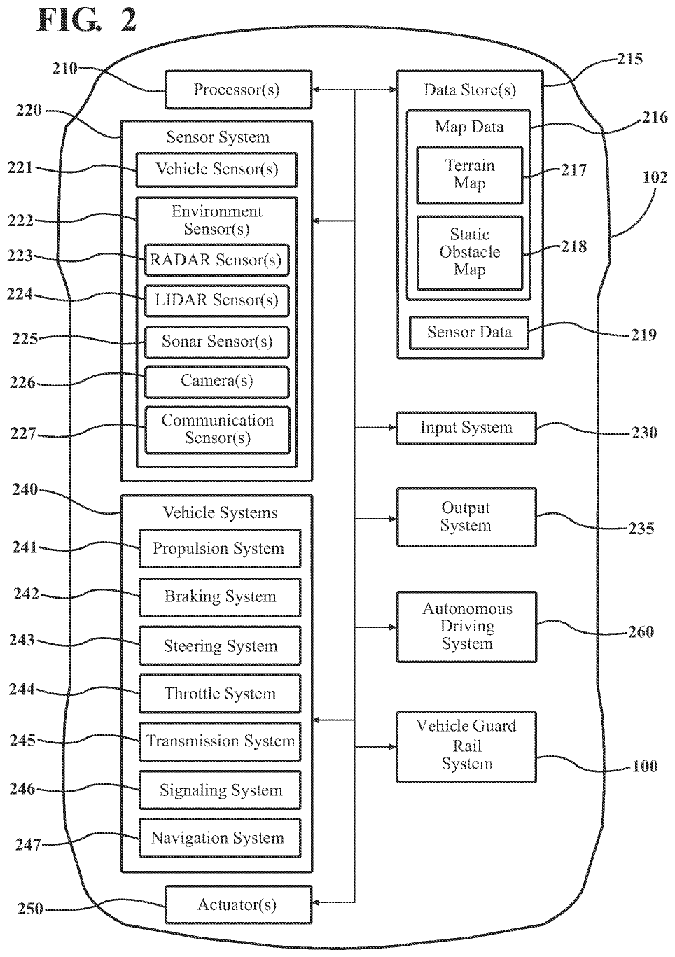

Referring to FIG. 2, a block diagram of the vehicle 102 incorporating a vehicle guard rail system 100 is illustrated. The vehicle 102 includes various elements. It will be understood that in various embodiments, it may not be necessary for the vehicle 102 to have all of the elements shown in FIG. 2. The vehicle 102 can have any combination of the various elements shown in FIG. 2. Further, the vehicle 102 can have additional elements to those shown in FIG. 2. In some arrangements, the vehicle 102 may be implemented without one or more of the elements shown in FIG. 2. While the various elements are shown as being located within the vehicle 102 in FIG. 2, it will be understood that one or more of these elements can be located external to the vehicle 102. Further, the elements shown may be physically separated by large distances. For example, as discussed, one or more components of the disclosed system can be implemented within a vehicle while further components of the system are implemented within a cloud-computing environment, as discussed further subsequently.

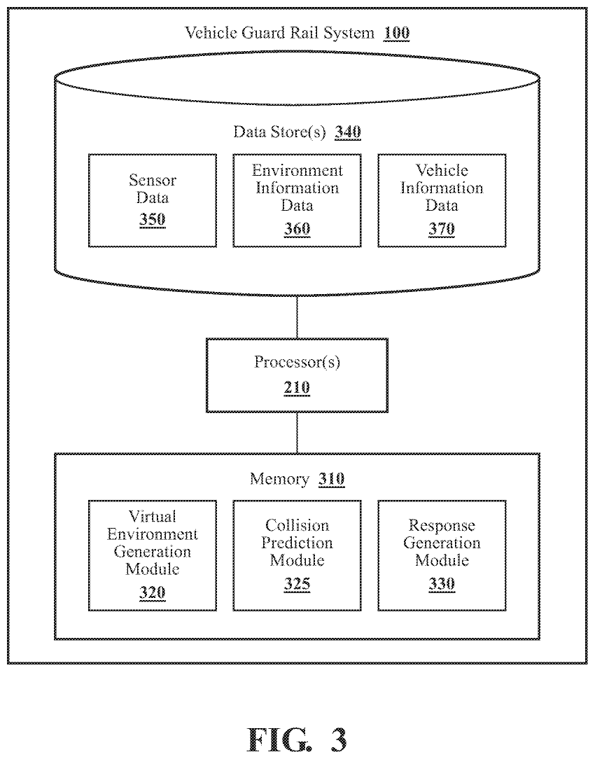

Some of the possible elements of the vehicle 102 are shown in FIG. 2 and will be described along with subsequent figures. However, a description of many of the elements in FIG. 2 will be provided after the discussion of FIGS. 3-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 2, the vehicle 102 includes a vehicle guard rail system 100 that is implemented to perform methods and other functions as disclosed herein relating to resolving one or more deficiencies in autonomous driving requirements for a road segment. As will be discussed in greater detail subsequently, the vehicle guard rail system 100, in various embodiments, may be implemented partially within the vehicle 102 and may further exchange communications with additional aspects of the vehicle guard rail system 100 that are remote from the vehicle 102 in support of the disclosed functions. Thus, while FIG. 3 generally illustrates the vehicle guard rail system 100 as being self-contained, in various embodiments, the vehicle guard rail system 100 may be implemented within multiple separate devices some of which may be remote from the vehicle 102.

With reference to FIG. 3, one embodiment of the vehicle guard rail system 100 of FIG. 2 is further illustrated. The vehicle guard rail system 100 is shown as including a processor 210 from the vehicle 102 of FIG. 2. Accordingly, the processor 210 may be a part of the vehicle guard rail system 100, the vehicle guard rail system 100 may include a separate processor from the processor 210 of the vehicle 102, and/or the vehicle guard rail system 100 may access the processor 210 through a data bus or another communication path. In further aspects, the processor 210 is a cloud-based resource that communicates with the vehicle guard rail system 100 through a communication network. In one embodiment, the vehicle guard rail system 100 includes a memory 310 that stores a virtual environment generation module 320, a collision prediction module 325, and a response generation module 330. The memory 310 is a random-access memory (RAM), read-only memory (ROM), a hard-disk drive, a flash memory, or other suitable memory for storing the modules 320, 325, and 330. The modules 320, 325, and 330 are, for example, computer-readable instructions within the physical memory 310 that when executed by the processor 210 cause the processor 210 to perform the various functions disclosed herein.

In one embodiment, the virtual environment generation module 320 includes instructions that function to control the processor 210 to generate a virtual environment 110 that includes a virtual version 111, 111B of the path 101 and a marker 114 indicating a demarcation along the path 101. The virtual environment 110 can include the environment surrounding the path 101. As an example, the virtual environment 110 can include shoulders, curbs and/or other paths that are proximate to the path 101 that the vehicle 102 is travelling on. As an example, the marker 114 can indicate a demarcation between two paths with traffic travelling in the same direction, between two paths with traffic travelling in opposite directions, and/or between a path and a shoulder or curb. The virtual environment generation module 320 can generate the virtual environment 110 based on sensor data 350 and/or environment information data 360.

In such a case, the sensor data 350 may originate from the sensor system 220 of the vehicle 102. Additionally and/or alternatively, the sensor data 350 may originate from one or more external sources. The external sources may include any entities capable of wireless communication such as other vehicles 102B, roadside units, servers, and/or databases 108.

The sensor data 350 may include detected vehicles 102, 102B, detected objects 106, and/or markings in the environment surrounding the vehicle 102. The sensor data 350 may further include metadata associated with the detected vehicles 102, 102B, objects 106, and markings. The associated metadata may indicate the type of the detected vehicle 102, 102B (e.g., a truck, a sedan, a bus, a motorcycle, a bicycle), and/or the type of object such as a pedestrian, an obstacle such as a rock, and a traffic device (e.g., traffic lights, road signs, etc.). The associated metadata may indicate the type of the detected marking such as a center line, and an edge line separating the path from the shoulder of the road. The metadata may include additional information associated with the detected object such as the geographic coordinates of the detected object. Additionally and/or alternatively, environment sensors 222 may determine the type of detected objects and/or markings based on observation and image recognition algorithms. The sensor data 350 may be in any suitable format such as point cloud maps, image files, and/or text files.

The sensor data 350 may be stored in a data store 340 of the vehicle guard rail system 100. Accordingly, in one embodiment, the vehicle guard rail system 100 includes the data store 340. The data store 340 is, in one embodiment, an electronic data structure (e.g., a database) stored in the memory 310 or another data store and that is configured with routines that can be executed by the processor 210 for analyzing stored data, providing stored data, organizing stored data, and so on. Thus, in one embodiment, the data store 340 stores data used by the modules 320, 325, and 330 in executing various functions. In one embodiment, the data store 340 includes the sensor data 350 along with, for example, environment information data 360, vehicle information data 370, and or other information that is used by the modules 320, 325, and 330.

The environment information data 360 may include information about physical characteristics of the environment surrounding the vehicle 102 such as the location, the dimensions, and the condition of the path(s) 101. The location of the path(s) 101 may include geographic coordinates of the path(s) 101, the position of the path(s) 101 relative to other paths, traffic rules based on the jurisdiction at the location of the path(s) 101, and traffic levels at the path(s) 101. The dimensions of the path(s) 101 may include the length of the path(s) 101, the width of the path(s) 101, the slope of the path(s) 101, the curvature of the path(s) 101, and/or the friction level of the path(s) 101. The condition of the path(s) 101 may include information about the physical condition of the path(s) 101 such as the presence of potholes, road debris, vegetation, occlusions and/or the presence of road delineators such as lane markers, road edge markers, traffic signs, traffic lights, and communicative roadside units. The location, dimensions and conditions of the path(s) 101 can be described as the path type.

Additionally and/or alternatively, the environment information data 360 can include conditions in the environment such as a weather condition, a road condition, and/or a timestamp. A weather condition may include, as an example, presence of precipitation such as snow, rain, and/or hail. The weather condition may further include impacts of weather such as fog levels, fallen snow levels (i.e. the amount of snow on the ground), and/or flooding. The weather condition may be updated periodically and/or on-demand.

The vehicle information data 370 can include information about various vehicle types such as model type, dimensions, and safety rankings. The vehicle information data can be an internal or external database that may updated periodically and/or on-demand.

As an example, the virtual environment generation module 320 may generate the virtual environment 110 by fusing together information received from the sensor data 350 and/or the environment information data 360. The virtual environment generation module 320 can determine the position and dimensions of the paths(s) 111 and/or marker(s) 114 based on the sensor data 350 and/or the environment information data 360. As an example, the virtual environment generation module 320 may align the path(s) 111 and/or marker(s) 114 based on the delineators detected by the sensors 222 and/or stored in the environment information data 360. As another example, the virtual environment generation module 320 may use any suitable algorithm such as a machine learning algorithm or an artificial intelligence process to determine the position and size of the path(s) 111 and/or marker(s) 114. The virtual environment generation module 320 can generate the virtual environment 110 in any suitable format such as a graphical format, a text format and/or a tabulated format. The virtual environment generation module 320 can output the virtual environment 110 to a display interface in the vehicle 102.

In one embodiment, the virtual environment generation module 320 includes instructions that function to control the processor 210 to generate a virtual rendition 112 of the vehicle 102 in the virtual environment 110. The virtual rendition 112 of the vehicle 102 can include a virtual version 118 of the vehicle 102 and one or more guard rails 120 that are spaced from the perimeter of the virtual version 118 of the vehicle 102. The virtual environment generation module 320 can generate the virtual rendition 112 of the vehicle 102 based on sensor data 350, environment information data 360, and/or vehicle information data 370.

The virtual environment generation module 320 can determine the locations and other characteristics of the vehicle 102, 102B from the sensor data 350. Additionally and/or alternatively, the virtual environment generation module 320 can determine the location and other characteristics of the vehicle 102, 102B from information received from the vehicle 102, 102B. As an example, the virtual environment generation module 320 may communicate with the vehicle 102, 102B using any suitable communication method such as V2V (vehicle-to-vehicle), V2I (vehicle-to-infrastructure), or V2X (vehicle-to-everything). As such, the virtual environment generation module 320 can request and receive information about the vehicle 102, 102B. As another example, the virtual environment generation module 320 can access vehicle information data 370 to determine the location of the vehicle 102, 102B, and the characteristics of the vehicle 102, 102B such as the model type and the dimensions of the vehicle 102, 102B.

Additionally and/or alternatively, the virtual environment generation module 320 can determine the location and other characteristics of the vehicle 102, 102B based on the information from the sensor data 350, the environment information data 360, and/or the vehicle information data 370. The virtual environment generation module 320 may use the determined locations and other characteristics of the vehicle 102, 102B and any suitable algorithm such as a machine learning algorithm or an artificial intelligence process to determine the position and dimensions of the virtual version 118, 118B of the vehicle 102, 102B relative to the virtual path(s) 111, 111B and/or marker(s) 114. The virtual environment generation module 320 can dynamically update the position of the virtual version 118, 118B of the vehicle 102, 102B as the position of the vehicle 102, 102B changes. The virtual environment generation module 320 can generate the virtual version 118, 118B of the vehicle 102, 102B in any suitable format such as a graphical format, a text format and/or a tabulated format. The virtual environment generation module 320 can output the virtual version 118, 118B of the vehicle 102, 102B to a display interface in the vehicle 102.

The virtual environment generation module 320 can determine the characteristics of the guard rails 120, 120B such as number of guard rails 120, 120B, the dimensions of the guard rails 120, 120B, the spacing between the guard rails 120, 120B, and the spacing between the guard rails 120, 120B and the virtual version 118, 118B of the vehicle 102, 102B.

As an example and as shown in FIG. 1, the guard rails 120, 120B can extend such that the guard rails 120, 120B are touching each other. In such an example, the virtual version 118, 118B of the vehicle 102, 102B is encompassed by the guard rails 120, 120B, and the guard rails 120, 120B can form a rectangle, a square, a circle, an oval shape, or any other suitable shape. As another example, the guard rails 120, 120B can be spaced from each other. As another example, the one or more guard rails 120, 120B can be spaced from one of more sides of the virtual version 118, 118B of the vehicle 102, 102B. The guard rails 120, 120B can be uniform in size and spacing from the virtual version 118, 118B of the vehicle 102, 102B. Alternatively, the guard rails 120, 120B may vary in size from each other and may vary in spacing from the virtual version 118, 118B of the vehicle 102, 102B.

The virtual environment generation module 320 can determine the characteristics of the one or more guard rails such as a size for the one or more guard rails based on at least one of a size of the vehicle, a size of the path, a speed of travel of the vehicle, severity of impact on the vehicle, vehicle type, path type, environmental conditions, or traffic conditions. As previously mentioned, the virtual environment generation module 320 can determine the size of the vehicle 102, 102B, the vehicle type, the speed of travel of the vehicle 102, 102B, the size of the path 101, the environmental conditions, and the traffic conditions.

The virtual environment generation module 320 can determine the severity of impact on the vehicle 102 based on various factors such as speed of travel of the vehicle 102 and surrounding vehicles 102B, size of the vehicle 102 and the surrounding vehicles 102B, safety ratings of the vehicle 102 and surrounding vehicles 102B, weather conditions, traffic conditions, and time of day. The virtual environment generation module 320 can use any suitable algorithm to determine the severity of impact on the vehicle 102.

In one embodiment, the virtual environment generation module 320 can determine that the severity of impact on the vehicle 102 is high and in such a case, the virtual environment generation module 320 can generate guard rails 120 with a larger spacing from the virtual version 118 of the vehicle 102. In such an embodiment, the spacing can be larger when the severity of impact on the vehicle 102 is higher, and the spacing can be smaller when the severity of impact on the vehicle 102 is lower. Alternatively and in another embodiment, the virtual environment generation module 320 can determine that the severity of impact on the vehicle 102 is high and in such a case, the virtual environment generation module 320 can generate a smaller spacing from the virtual version 118 of the vehicle 102. In such an embodiment, the spacing can be smaller when the severity of impact on the vehicle 102 is higher, and the spacing can be larger when the severity of impact on the vehicle 102 is lower.

As another example, the virtual environment generation module 320 can determine that the characteristics of the guard rails 120, 120B by user entry. In such an example, the user may be able to input and adjust the characteristics using an input interface in the vehicle 102.

The virtual environment generation module 320 may include instructions that function to control the processor 210 to generate a virtual rendition 116 of an object 106 in the virtual environment 110. The object 106 can be proximate to the vehicle 102, and the virtual rendition 116 of the object 106 can include a virtual version 122 of the object 106 and one or more guard rails 124 that are spaced from the perimeter of the virtual version 122 of the object 106. As an example, the virtual environment generation module 320 can determine the position and size of the object 106 based on sensor data 350. As another example, in the case where the object 106 has communication capabilities, the virtual environment generation module 320 can communicate with the object 106 and receive information about the object characteristics. In such an example, the virtual environment generation module 320 can determine the position and size of the object 106 based on the received information. The virtual environment generation module 320 can generate the one or more guard rails 124 spaced from the object 106. The virtual environment generation module 320 can determine the size and spacing of the guard rails 124 based on the characteristics of the object 106 such as the position and/or size of the object 106, the type of object 106, and the whether the object 106 is mobile or immobile.

In one embodiment, the collision prediction module 325 includes instructions that function to control the processor 210 to predict whether the virtual rendition 112 of the vehicle 102 will intersect with the marker 114. As an example, the collision prediction module 325 can monitor the virtual rendition 112 of the vehicle 102 to determine whether one or more guard rails 120 has intersected with the marker 114. In such an example, the collision prediction module 325 can predict that the vehicle 102 will veer out of its present path when one or more guard rails 120 touch or overlap the marker 114.

As another example, the collision prediction module 325 can determine the direction of travel of the vehicle 102 based on the present and past positions of the virtual rendition 112 of the vehicle 102 in the virtual environment 110. The collision prediction module 325 can determine the trajectory of the virtual rendition 112 of vehicle 102 and can extrapolate the trajectory to determine whether the extrapolated trajectory intersects with the marker 114. In the case where the extrapolated trajectory intersects with the marker 114, the collision prediction module 325 can predict that the virtual rendition 112 of the vehicle 102 will intersect with the marker 114.

In one embodiment, the collision prediction module 325 includes instructions that function to control the processor 210 to predict whether the virtual rendition 112 of the vehicle 102 will intersect with the virtual rendition 116 of the object 106. As an example, the collision prediction module 325 can monitor the virtual renditions 112, 116 of the vehicle 102 and the object 106 to determine whether one or more guard rails 120 of the vehicle 102 has intersected with one or more guard rails 124 of the object 106. In such an example, the collision prediction module 325 can predict that the vehicle 102 will collide with the object 106 when the guard rails 120, 124 of the vehicle 102 and the object 106 touch or overlap.

As another example, the collision prediction module 325 can determine the direction of travel of the vehicle 102 and the object 106 based on the present and past positions of the virtual renditions 112, 116 of the vehicle 102 and the object 106 in the virtual environment 110, respectively. The collision prediction module 325 can determine the trajectories of the virtual renditions 112, 116 of the vehicle 102 and the object 106, and can extrapolate the trajectories to determine whether the extrapolated trajectories intersect with each other. In the case where the extrapolated trajectories intersect with each other, the collision prediction module 325 can predict that the virtual rendition 112 of the vehicle 102 will intersect with the virtual rendition 116 of the object 106.

The response generation module 330 includes instructions that function to control the processor 210 to determine an act that can assist in preventing the virtual rendition 112 of the vehicle 102 from intersecting with the marker 114. In one embodiment, the response generation module 330 can determine the act in response to the collision prediction module 325 predicting that the virtual rendition 112 of the vehicle 102 will intersect with the marker 114. In another embodiment, the response generation module 330 can determine the act in response to the collision prediction module 325 predicting that the virtual rendition 112 of the vehicle 102 will intersect with the virtual rendition 112B, 116 of another vehicle 102B and/or object 106.

In one example, the act can include outputting at least one of a visual alert, an audible alert, and a haptic alert in the vehicle 102. As an example, the visual alert can be displayed on a display interface in the vehicle 102 that is visible to the vehicle operator. As another example, the audible alert can be output on the vehicle speakers. As another example, the haptic alert can cause a vehicle seat and/or a steering wheel to vibrate. Characteristics of the alerts such as volume, pitch, and/or intensity may vary based on the level of certainty that the virtual rendition 112 of the vehicle 102 will intersect with the marker 114, the virtual rendition 112B of another vehicle 102B, and/or the virtual rendition 116 of the object 106.

In another example, the act can include assuming control of the vehicle 102. As an example, the response generation module 330 can activate one or more vehicle systems such as the braking system 242, the steering system 243, and the autonomous driving system 260. The response generation module 330 can communicate with the one or more vehicle systems 240 using any suitable communications method. The response generation module 330 can determine a suitable action that would assist in preventing the virtual rendition 112 of the vehicle 102 from intersecting with the marker 114. As an example, the response generation module 330 can instruct the braking system 242 to activate the brakes or the steering system 243 to turn the steering wheel.

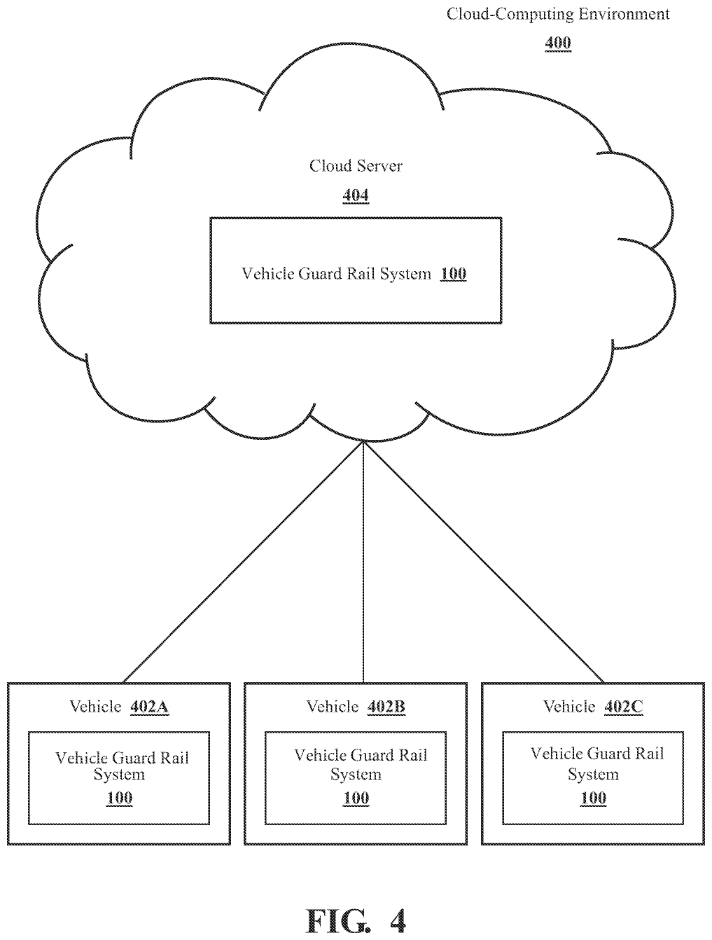

The vehicle guard rail system 100 may be further implemented as a cloud-based system that functions within a cloud-computing environment 400 as illustrated in relation to FIG. 4. That is, for example, the vehicle guard rail system 100 may acquire telematics data (i.e., sensor data 350) from vehicles, and environment information data 360 and/or vehicle information data from external sources such as an external database. The vehicle guard rail system 100 can execute as a cloud-based resource that is comprised of devices (e.g., servers 404) remote from the vehicle 102 to guide the vehicle 102 along the path 101. Accordingly, the vehicle guard rail system 100 may communicate with vehicles (e.g., vehicles 402A, 402B, and 402C) that are geographically distributed. In one approach, a cloud-based vehicle guard rail system 100 can collect the data 350, 360, 370 from components or separate instances of the vehicle guard rail system 100 that are integrated with the vehicles 402A, 402B, 402C.

Along with the communications, the vehicles 402A, 402B, 402C may provide sensor data 350. As such, the cloud-based aspects of the vehicle guard rail system 100 may then process the sensor data 350 separately for the vehicles 402A, 402B, 402C to generate the virtual environment 110, the marker 114, the virtual rendition 112, 112B of the vehicle 102, 102B, and/or the virtual rendition 116 of proximate objects 106. In further aspects, vehicle-based systems may perform part of the processing while the cloud-computing environment 400 may handle a remaining portion or function to validate results of the vehicle-based systems. It should be appreciated that apportionment of the processing between the vehicle 402A, 402B, 402C and the cloud may vary according to different implementations. Additional aspects of the cloud-computing environment 400 are discussed above in relation to components of the vehicle guard rail system 100 and FIG. 3.

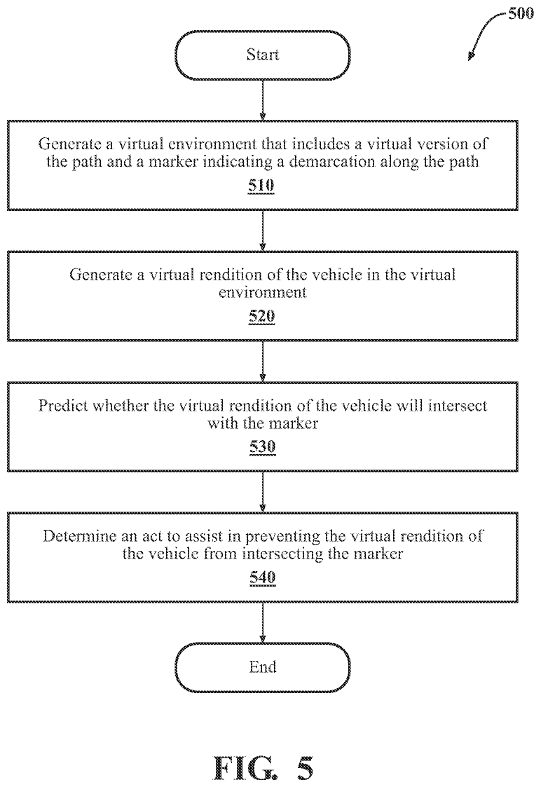

FIG. 5 illustrates a method 500 for guiding a vehicle along a path. The method 500 will be described from the viewpoint of the vehicle 102 of FIG. 2 and the vehicle guard rail system 100 of FIG. 3. However, the method 500 may be adapted to be executed in any one of several different situations and not necessarily by the vehicle 102 of FIG. 2 and/or the vehicle guard rail system 100 of FIG. 3.

At step 510, the virtual environment generation module 320 may cause the processor(s) 210 to generate a virtual environment 110 that includes a virtual version 111, 111B of the path 101 and a marker 114 indicating a demarcation along the path 101. As previously mentioned, the virtual environment generation module 320 may generate the virtual environment 110 based on sensor data 350 and/or environment information data 360.

At step 520, the virtual environment generation module 320 may cause the processor(s) 210 to generate a virtual rendition 112, 112B of the vehicle 102,102B in the virtual environment 110. As previously mentioned, the virtual environment generation module 320 may generate the virtual rendition 112, 112B of the vehicle 102, 102B based on sensor data 350, environment information data 360 and/or vehicle information data 370.

At step 530, the collision prediction module 325 may cause the processor(s) 210 to predict whether the virtual rendition 112 of the vehicle 102 will intersect with the marker 114, as discussed above.

At step 540, the response generation module 330 may cause the processor(s) 210 to determine an act to assist in preventing the virtual rendition 112 of the vehicle 102 from intersecting with the marker 114, as previously discussed.

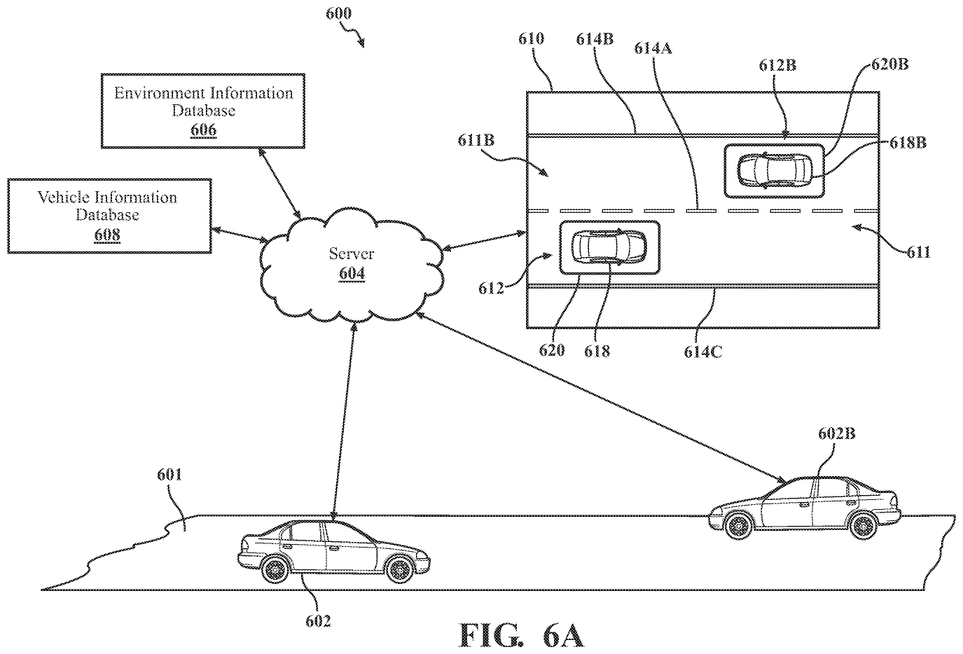

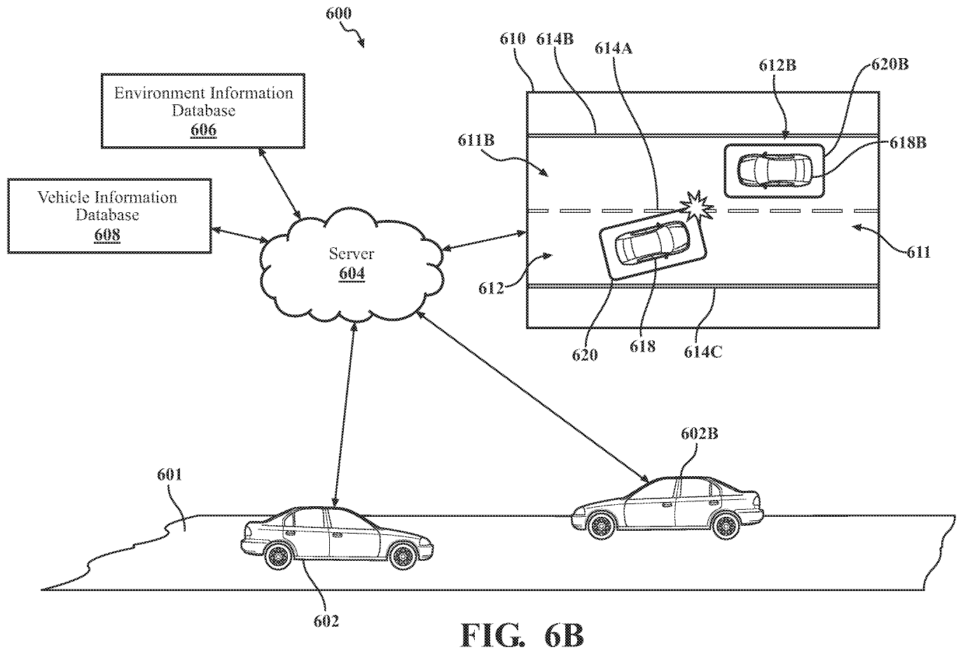

A non-limiting example of the operation of the vehicle guard rail system 100 and/or one or more of the methods will now be described in relation to FIGS. 6A-6B. FIGS. 6A-6B show an example of a vehicle guidance scenario.

In FIGS. 6A-6B, the vehicle 602, which is similar to vehicle 102, may be travelling on a two-way road 601 that does not have a visible center line mark. In FIG. 6A, the vehicle 602 is travelling in one direction and a second vehicle 602B is travelling in the opposite direction.

The vehicle guard rail system 600, or more specifically, the virtual environment generation module 320 may receive sensor data 350 from the vehicle 602 via a cloud server 604. The virtual environment generation module 320 may receive additional information from external sources such as sensor data 350 from the second vehicle 602B, environment information data 360 from an environment information database 606, and vehicle information data 370 from a vehicle information database 608 via the cloud server 604. The virtual environment generation module 320 can generate a virtual environment 610 with a marker 614A indicating a center line that separates the traffic in one direction from the traffic in the opposite direction, and markers 614B, 614C indicating edges of the path 601. The virtual environment generation module 320 can generate virtual renditions 612, 612B of the vehicles 602, 602B. The virtual rendition 612 includes a virtual version 618 of the vehicle 602 travelling on a path 611, and the virtual rendition 612B includes a virtual version 618B of the vehicle 602B travelling on a path 611B.

The vehicle guard rail system 600, or more specifically the collision prediction module 325, can monitor the position of the virtual renditions 612, 612B to determine if the virtual renditions 612, 612B are touching the marker 614A. As shown in this case, the virtual renditions 612, 612A, particularly the guard rails 620, 620B are not touching the marker 614A and so, the collision prediction module 325 can predict that neither virtual rendition 612, 612B will intersect with the marker. This indicates that a collision is unlikely and there is no need to determine an act to assist in preventing the virtual rendition 612 of the vehicle 602 from intersecting with the marker 614A.

In FIG. 6B, the vehicle 602 is travelling in one direction and a second vehicle 602B is travelling in the opposite direction. The vehicle 602 is veering towards the center.

The vehicle guard rail system 100, or more specifically, the virtual environment generation module 320 may receive sensor data 350 from the vehicle 602. The virtual environment generation module 320 may receive additional information from external sources such as sensor data from the second vehicle 602B, environment information data 360 from an environment information database 606, and vehicle information data 370 from a vehicle information database 608. The virtual environment generation module 320 can generate a virtual environment 610 with a marker 614 indicating a center line that separates the traffic in one direction from the traffic in the opposite direction. The virtual environment generation module 320 can generate virtual renditions 612, 612B of the vehicles 602, 602B.

The vehicle guard rail system 600, or more specifically the collision prediction module 325, can monitor the positions of the virtual renditions 612, 612B to determine if the virtual renditions 612, 612B are touching the marker 614. As shown in this case, the virtual rendition 612 of the vehicle 602, particularly the guard rail 620, is touching the marker and so, the collision prediction module 325 can predict that the virtual rendition 612 will intersect with the marker 614A. This indicates that a collision is likely and there is a need to determine an act to assist in preventing the virtual rendition 612 of the vehicle 602 from intersecting with the marker 614.

The vehicle guard rail system 100, or more specifically the response generation module 330, can determine an act to assist in preventing the virtual rendition 612 of the vehicle from intersecting with the marker 614. As previously mentioned and as an example, the response generation module 330 can output an alert such as a visual alert, an audible alert, and/or a haptic alert in the vehicle 602. As another example, the response generation module 330 can take control of a function of the vehicle 602 such as the braking function and/or the steering function.

FIG. 2 will now be discussed in full detail as an example environment within which the system and methods disclosed herein may operate. In some instances, the vehicle 102 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 102 can be a conventional vehicle that is configured to operate in only a manual mode.

In one or more embodiments, the vehicle 102 is an autonomous vehicle. As used herein, “autonomous vehicle” refers to a vehicle that operates in an autonomous mode. “Autonomous mode” refers to navigating and/or maneuvering the vehicle 102 along a travel route using one or more computing systems to control the vehicle 102 with minimal or no input from a human driver. In one or more embodiments, the vehicle 102 is highly automated or completely automated. In one embodiment, the vehicle 102 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 102 along a travel route.

The vehicle 102 can include one or more processors 210. In one or more arrangements, the processor(s) 210 can be a main processor of the vehicle 102. For instance, the processor(s) 210 can be an electronic control unit (ECU). The vehicle 102 can include one or more data stores 215 for storing one or more types of data. The data store 215 can include volatile and/or non-volatile memory. Examples of suitable data stores 215 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 215 can be a component of the processor(s) 210, or the data store 215 can be operatively connected to the processor(s) 210 for use thereby. The term “operatively connected,” as used throughout this description, can include direct or indirect connections, including connections without direct physical contact.

In one or more arrangements, the one or more data stores 215 can include map data 216. The map data 216 can include maps of one or more geographic areas. In some instances, the map data 216 can include information or data on roads, traffic control devices, road markings, structures, features, and/or landmarks in the one or more geographic areas. The map data 216 can be in any suitable form. In some instances, the map data 216 can include aerial views of an area. In some instances, the map data 216 can include ground views of an area, including 360-degree ground views. The map data 216 can include measurements, dimensions, distances, and/or information for one or more items included in the map data 216 and/or relative to other items included in the map data 216. The map data 216 can include a digital map with information about road geometry. The map data 216 can be high quality and/or highly detailed.

In one or more arrangements, the map data 216 can include one or more terrain maps 217. The terrain map(s) 217 can include information about the ground, terrain, roads, surfaces, and/or other features of one or more geographic areas. The terrain map(s) 217 can include elevation data in the one or more geographic areas. The map data 216 can be high quality and/or highly detailed. The terrain map(s) 217 can define one or more ground surfaces, which can include paved roads, unpaved roads, land, and other things that define a ground surface.

In one or more arrangements, the map data 216 can include one or more static obstacle maps 218. The static obstacle map(s) 218 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 218 can have location data, size data, dimension data, material data, and/or other data associated with it. The static obstacle map(s) 218 can include measurements, dimensions, distances, and/or information for one or more static obstacles. The static obstacle map(s) 218 can be high quality and/or highly detailed. The static obstacle map(s) 218 can be updated to reflect changes within a mapped area.

The one or more data stores 215 can include sensor data 219. In this context, “sensor data” means any information about the sensors that the vehicle 102 is equipped with, including the capabilities and other information about such sensors. As will be explained below, the vehicle 102 can include the sensor system 220. The sensor data 219 can relate to one or more sensors of the sensor system 220. As an example, in one or more arrangements, the sensor data 219 can include information on one or more LIDAR sensors 224 of the sensor system 220.

In some instances, at least a portion of the map data 216 and/or the sensor data 219 can be located in one or more data stores 215 located onboard the vehicle 102. Alternatively, or in addition, at least a portion of the map data 216 and/or the sensor data 219 can be located in one or more data stores 215 that are located remotely from the vehicle 102.

As noted above, the vehicle 102 can include the sensor system 220. The sensor system 220 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 220 includes a plurality of sensors, the sensors can work independently from each other. Alternatively, two or more of the sensors can work in combination with each other. In such a case, the two or more sensors can form a sensor network. The sensor system 220 and/or the one or more sensors can be operatively connected to the processor(s) 210, the data store(s) 215, and/or another element of the vehicle 102 (including any of the elements shown in FIG. 2). The sensor system 220 can acquire data of at least a portion of the external environment of the vehicle 102 (e.g., nearby vehicles).

The sensor system 220 can include any suitable type of sensor. Various examples of different types of sensors will be described herein. However, it will be understood that the embodiments are not limited to the particular sensors described. The sensor system 220 can include one or more vehicle sensors 221. The vehicle sensor(s) 221 can detect, determine, and/or sense information about the vehicle 102 itself. In one or more arrangements, the vehicle sensor(s) 221 can be configured to detect, and/or sense position and orientation changes of the vehicle 102, such as, for example, based on inertial acceleration. In one or more arrangements, the vehicle sensor(s) 221 can include one or more accelerometers, one or more gyroscopes, an inertial measurement unit (IMU), a dead-reckoning system, a global navigation satellite system (GNSS), a global positioning system (GPS), a navigation system 247, and/or other suitable sensors. The vehicle sensor(s) 221 can be configured to detect, and/or sense one or more characteristics of the vehicle 102. In one or more arrangements, the vehicle sensor(s) 221 can include a speedometer to determine a current speed of the vehicle 102.

Alternatively, or in addition, the sensor system 220 can include one or more environment sensors 222 configured to acquire, and/or sense driving environment data. “Driving environment data” includes data or information about the external environment in which the vehicle is located or one or more portions thereof. For example, the one or more environment sensors 222 can be configured to detect, quantify and/or sense obstacles in at least a portion of the external environment of the vehicle 102 and/or information/data about such obstacles. Such obstacles may be stationary objects and/or dynamic objects. The one or more environment sensors 222 can be configured to detect, measure, quantify and/or sense other objects in the external environment of the vehicle 102, such as, for example, lane markers, signs, traffic lights, traffic signs, lane lines, crosswalks, curbs proximate the vehicle 102, off-road objects, electronic roadside devices, etc. The one or more environment sensors 222 can be configured to determine whether the objects with electronic capability are functional by wirelessly transmitting messages to and receiving messages from the objects.

Various examples of sensors of the sensor system 220 will be described herein. The example sensors may be part of the one or more environment sensors 222 and/or the one or more vehicle sensors 221. However, it will be understood that the embodiments are not limited to the particular sensors described.

As an example, in one or more arrangements, the sensor system 220 can include one or more radar sensors 223, one or more LIDAR sensors 224, one or more sonar sensors 225, one or more cameras 226, and/or one or more communication sensors 227. In one or more arrangements, the one or more cameras 226 can be high dynamic range (HDR) cameras or infrared (IR) cameras. The communication sensor(s) 227 such as radio frequency identification (RFID) and near-field communication (NFC) readers may communicate with electronic objects such as RFID and/or NFC tags in the environment using any suitable means of communication such as Wi-Fi, Bluetooth, vehicle-to-infrastructure (V2I) wireless communication, vehicle-to-everything (V2X) wireless communication, RFIC, and NFC.

The vehicle 102 can include an input system 230. An “input system” includes any device, component, system, element or arrangement or groups thereof that enable information/data to be entered into a machine. The input system 230 can receive an input from a vehicle passenger (e.g., a driver or a passenger). The vehicle 102 can include an output system 235. An “output system” includes any device, component, or arrangement or groups thereof that enable information/data to be presented to a vehicle passenger (e.g., a person, a vehicle passenger, etc.) such as a display interface.

The vehicle 102 can include one or more vehicle systems 240. Various examples of the one or more vehicle systems 240 are shown in FIG. 2. However, the vehicle 102 can include more, fewer, or different vehicle systems. It should be appreciated that although particular vehicle systems are separately defined, each or any of the systems or portions thereof may be otherwise combined or segregated via hardware and/or software within the vehicle 102. The vehicle 102 can include a propulsion system 241, a braking system 242, a steering system 243, throttle system 244, a transmission system 245, a signaling system 246, and/or a navigation system 247. Each of these systems can include one or more devices, components, and/or a combination thereof, now known or later developed.

The navigation system 247 can include one or more devices, applications, and/or combinations thereof, now known or later developed, configured to determine the geographic location of the vehicle 102 and/or to determine a travel route for the vehicle 102. The navigation system 247 can include one or more mapping applications to determine a travel route for the vehicle 102. The navigation system 247 can include a global positioning system, a local positioning system or a geolocation system.

The processor(s) 210, the vehicle guard rail system 100, and/or the autonomous driving system(s) 260 can be operatively connected to communicate with the various vehicle systems 240 and/or individual components thereof. For example, returning to FIG. 2, the processor(s) 210 and/or the autonomous driving system(s) 260 can be in communication to send and/or receive information from the various vehicle systems 240 to control the movement, speed, maneuvering, heading, direction, etc. of the vehicle 102. The processor(s) 210, the vehicle guard rail system 100, and/or the autonomous driving system(s) 260 may control some or all of these vehicle systems 240 and, thus, may be partially or fully autonomous.

The processor(s) 210, the vehicle guard rail system 100, and/or the autonomous driving system(s) 260 can be operatively connected to communicate with the various vehicle systems 240 and/or individual components thereof. For example, returning to FIG. 2, the processor(s) 210, the vehicle guard rail system 100, and/or the autonomous driving system(s) 260 can be in communication to send and/or receive information from the various vehicle systems 240 to control the movement, speed, maneuvering, heading, direction, etc. of the vehicle 102. The processor(s) 210, the vehicle guard rail system 100, and/or the autonomous driving system(s) 260 may control some or all of these vehicle systems 240.

The processor(s) 210, the vehicle guard rail system 100, and/or the autonomous driving system(s) 260 may be operable to control the navigation and/or maneuvering of the vehicle 102 by controlling one or more of the vehicle systems 240 and/or components thereof. For instance, when operating in an autonomous mode, the processor(s) 210, the vehicle guard rail system 100, and/or the autonomous driving system(s) 260 can control the direction and/or speed of the vehicle 102. The processor(s) 210, the vehicle guard rail system 100, and/or the autonomous driving system(s) 260 can cause the vehicle 102 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 102 can include one or more actuators 250. The actuators 250 can be any element or combination of elements operable to modify, adjust and/or alter one or more of the vehicle systems 240 or components thereof to responsive to receiving signals or other inputs from the processor(s) 210 and/or the autonomous driving system(s) 260. Any suitable actuator can be used. For instance, the one or more actuators 250 can include motors, pneumatic actuators, hydraulic pistons, relays, solenoids, and/or piezoelectric actuators, just to name a few possibilities.

The vehicle 102 can include one or more modules, at least some of which are described herein. The modules can be implemented as computer-readable program code that, when executed by a processor 210, implement one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively, or in addition, one or more data store 215 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 102 can include one or more autonomous driving systems 260. The autonomous driving system(s) 260 can be configured to receive data from the sensor system 220 and/or any other type of system capable of capturing information relating to the vehicle 102 and/or the external environment of the vehicle 102. In one or more arrangements, the autonomous driving system(s) 260 can use such data to generate one or more driving scene models. The autonomous driving system(s) 260 can determine position and velocity of the vehicle 102. The autonomous driving system(s) 260 can determine the location of obstacles, obstacles, or other environmental features including traffic signs, trees, shrubs, neighboring vehicles, pedestrians, etc.

The autonomous driving system(s) 260 can be configured to receive, and/or determine location information for obstacles within the external environment of the vehicle 102 for use by the processor(s) 210, and/or one or more of the modules described herein to estimate position and orientation of the vehicle 102, vehicle position in global coordinates based on signals from a plurality of satellites, or any other data and/or signals that could be used to determine the current state of the vehicle 102 or determine the position of the vehicle 102 with respect to its environment for use in either creating a map or determining the position of the vehicle 102 in respect to map data.

The autonomous driving system(s) 260 either independently or in combination with the vehicle guard rail system 100 can be configured to determine travel path(s), current autonomous driving maneuvers for the vehicle 102, future autonomous driving maneuvers and/or modifications to current autonomous driving maneuvers based on data acquired by the sensor system 220, driving scene models, and/or data from any other suitable source such as determinations from the sensor data 219. “Driving maneuver” means one or more actions that affect the movement of a vehicle. Examples of driving maneuvers include: accelerating, decelerating, braking, turning, moving in a lateral direction of the vehicle 102, changing travel lanes, merging into a travel lane, and/or reversing, just to name a few possibilities. The autonomous driving system(s) 260 can be configured to implement determined driving maneuvers. The autonomous driving system(s) 260 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving system(s) 260 can be configured to execute various vehicle functions and/or to transmit data to, receive data from, interact with, and/or control the vehicle 102 or one or more systems thereof (e.g., one or more of vehicle systems 240).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8 but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for guiding a vehicle along a path, the method comprising the steps of:
generating a virtual environment that includes a virtual version of the path and a marker indicating a demarcation along the path;
generating a virtual rendition of the vehicle in the virtual environment, the virtual rendition of the vehicle including a virtual version of the vehicle and one or more guard rails that are spaced from a perimeter of the virtual version of the vehicle;
predicting whether the virtual rendition of the vehicle will intersect with the marker; and
determining an act to assist in preventing the virtual rendition of the vehicle from intersecting with the marker.

2. The method of claim 1, wherein the act includes outputting at least one of a visual alert, an audible alert, and a haptic alert in the vehicle.

3. The method of claim 1, wherein the act includes assuming control of the vehicle.

4. The method of claim 1, further comprising:
generating a virtual rendition of an object in the virtual environment, wherein the object is proximate to the vehicle, wherein the virtual rendition of the object includes a virtual version of the object and one or more guard rails that are spaced from a perimeter of the virtual version of the object.

5. The method of claim 4, further comprising:
predicting whether the virtual rendition of the vehicle will intersect with the virtual rendition of the object; and
determining an act to assist in preventing the virtual rendition of the vehicle from intersecting with the virtual rendition of the object.

6. The method of claim 1, further comprising:
determining a size for the one or more guard rails based on at least one of:
a size of the vehicle;
a size of the path;
a speed of travel of the vehicle;
severity of impact on the vehicle;
vehicle type;
path type;
environmental conditions; or
traffic conditions.

7. The method of claim 1, wherein predicting whether the virtual rendition of the vehicle will intersect with the marker is based on at least one of:
a speed of travel of the vehicle; or
a direction of travel of the vehicle.

8. A system for guiding a vehicle along a path, the system comprising:
one or more processors; and
a memory in communication with the one or more processors, the memory including:
a virtual environment generation module including instructions that when executed by the one or more processors cause the one or more processors to:
generate a virtual environment that includes a virtual version of the path and a marker indicating a demarcation along the path; and
generate a virtual rendition of the vehicle in the virtual environment, the virtual rendition of the vehicle including a virtual version of the vehicle and one or more guard rails that are spaced from a perimeter of the virtual version of the vehicle;
a collision prediction module including instructions that when executed by the one or more processors cause the one or more processors to:
predict whether the virtual rendition of the vehicle will intersect with the marker; and
a response generation module including instructions that when executed by the one or more processors cause the one or more processors to:
determine an act to assist in preventing the virtual rendition of the vehicle from intersecting with the marker.

9. The system of claim 8, wherein the act includes outputting at least one of a visual alert, an audible alert, and a haptic alert in the vehicle.

10. The system of claim 8, wherein the act includes assuming control of the vehicle.

11. The system of claim 8, wherein the virtual environment generation module further includes instructions that when executed by the one or more processors cause the one or more processors to generate a virtual rendition of an object in the virtual environment, wherein the object is proximate to the vehicle, wherein the virtual rendition of the object includes a virtual version of the object and one or more guard rails that are spaced from a perimeter of the virtual version of the object.

12. The system of claim 11, wherein the collision prediction module further includes instructions that when executed by the one or more processors cause the one or more processors to predict whether the virtual rendition of the vehicle will intersect with the virtual rendition of the object; and wherein the response generation module further includes instructions that when executed by the one or more processors cause the one or more processors to determine an act to assist in preventing the virtual rendition of the vehicle from intersecting with the virtual rendition of the object.

13. The system of claim 8, wherein the virtual environment generation module further includes instructions that when executed by the one or more processors cause the one or more processors to determine a size for the one or more guard rails based on at least one of:
a size of the vehicle;
a size of the path;
a speed of travel of the vehicle;
severity of impact on the vehicle;
vehicle type;
path type;
environmental conditions; or
traffic conditions.

14. The system of claim 8, wherein the collision prediction module further includes instructions that when executed by the one or more processors cause the one or more processors to predict whether the virtual rendition of the vehicle will intersect with the marker is based on at least one of:
a speed of travel of the vehicle; or
a direction of travel of the vehicle.

15. A non-transitory computer-readable medium for guiding a vehicle along a path and including instructions that when executed by one or more processors cause the one or more processors to:
generate a virtual environment that includes a virtual version of the path and a marker indicating a demarcation along the path;
generate a virtual rendition of the vehicle in the virtual environment, the virtual rendition of the vehicle including a virtual version of the vehicle and one or more guard rails that are spaced from a perimeter of the virtual version of the vehicle;
predict whether the virtual rendition of the vehicle will intersect with the marker; and
determining an act to assist in preventing the virtual rendition of the vehicle from intersecting with the marker.

16. The non-transitory computer-readable medium of claim 15, wherein the act includes outputting at least one of a visual alert, an audible alert, and a haptic alert in the vehicle.

17. The non-transitory computer-readable medium of claim 15, wherein the act includes assuming control of the vehicle.

18. The non-transitory computer-readable medium of claim 15, wherein the instructions further include instructions that when executed by the one or more processors cause the one or more processors to generate a virtual rendition of an object in the virtual environment, wherein the object is proximate to the vehicle, wherein the virtual rendition of the object includes a virtual version of the object and one or more guard rails that are spaced from a perimeter of the virtual version of the object.

19. The non-transitory computer-readable medium of claim 18, wherein the instructions further include instructions that when executed by the one or more processors cause the one or more processors to:
predict whether the virtual rendition of the vehicle will intersect with the virtual rendition of the object; and
determine an act to assist in preventing the virtual rendition of the vehicle from intersecting with the virtual rendition of the object.

20. The non-transitory computer-readable medium of claim 15, wherein the instructions further include instructions that when executed by the one or more processors cause the one or more processors to determine a size for the one or more guard rails based on at least one of:
a size of the vehicle;
a size of the path;
a speed of travel of the vehicle;
severity of impact on the vehicle;
vehicle type;
path type;
environmental conditions; or
traffic conditions.
